(19) United States
(12) Patent Application Publication
(10) Pub. No.: US 2007/0113247 A1
(43) Pub. Date: May 17, 2007

(54) Method and apparatus for providing user interface

(75) Inventor: Ji-yeon Kwak, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/580,193

(22) Filed: Oct. 13, 2006

(30) Foreign Application Priority Data
Nov. 16, 2005 (KR) 2005-109902

(51) Int. Cl. H04N 5/445; G06F 13/00; G06F 3/00; H04N 5/45

(52) U.S. Cl. 725/43; 348/564; 348/565; 725/38

(57) ABSTRACT

A method and apparatus which provides a user interface includes a method of providing a plurality of display areas corresponding to a control subject, positioning a point object on one display area of the several display areas, and moving the pointing object between the plurality of display areas as a move command is input. The apparatus includes a display control module that provides a plurality of display areas which each display a control subject, and a pointing object control module that overlaps a pointing object on one display area of the plurality of display areas and moves the pointing object between the plurality of display areas when a move command is input.

### CROSS-REFERENCE TO RELATED APPLICATION

This application claims priority from Korean Patent Application No. 2005-109902 filed on Nov. 16, 2005, in the Korean Intellectual Property Office, the disclosure of which is incorporated herein by reference in its entirety.

### BACKGROUND OF THE INVENTION

1. Field of the Invention

Aspects of the present invention relate to a user interface and, more particularly, to a method and an apparatus for providing a user interface, which displays and controls a control subject by using a pointing object.

2. Description of the Related Art

When a conventional analog broadcast is received by a moving terminal, its sound and image qualities are significantly decreased, so a high output power and a wide bandwidth are required to compensate for the decrease in sound and image qualities. In order to provide a high output power and wide bandwidth, digital broadcasts, such as digital audio broadcasts, digital video broadcasts, and digital data broadcasts are being standardized.

For example, digital audio broadcasting (DAB), which has been developed as a next generation broadcast format in Europe, where Eureka-147 has been selected as the digital audio broadcast standard, is not affected by radio waves or noise, and thereby facilitates playing back an audio broadcast at CD quality in a mobile environment, even when the broadcast is transmitted using a low output power. DAB transmits not only music but also various multimedia information regarding news, traffic, weather, global positioning, and moving pictures. As a result, the concept of listening to a radio broadcast has been broadened to the concept of “viewing and listening.”

Digital multimedia broadcasts (DMB) are another format of next generation broadcasts that enable a mobile terminal to receive and restore several digital broadcasts by transmitting CD quality sound, text, graphics, and moving pictures at 1.5 Mbits/s beyond the conventional transmission speed of AM and FM broadcasts.

As digital broadcasts become more prevalent, the spread of portable broadcast-receiving devices capable of receiving digital broadcasts such as DAB and DMB, while the devices are in motion, is increasing. A portable broadcast-receiving device is usually small due to the nature of mobile terminals. Therefore, it is essential that the number of buttons which control the portable broadcast-receiving device is limited, and the screen size of the portable broadcast-receiving device is compact. Accordingly, an appropriate user interface is needed which enables a user to easily control a portable broadcast-receiving device.

### SUMMARY OF THE INVENTION

In view of the above, it is an aspect of the present invention to provide a user interface which uses a pointing object in order to easily control a portable broadcast-receiving device.

Additional aspects and/or advantages of the invention will be set forth in part in the description which follows and, in part, will be obvious from the description, or may be learned by practice of the invention.

An aspect of the present invention provides a method of providing a user interface to a user.

According to an aspect of the invention, the method includes displaying a plurality of display areas which each display a control subject, positioning a pointing object on one display area of the several display areas, and moving the pointing object between the plurality of display areas when a move command is input.

Another aspect of the present invention provides an apparatus which provides a user interface to a user.

According to another aspect of the present invention, the apparatus includes a display control module having a plurality of display areas which display control subjects, and a pointing object control module which moves the pointing object displayed on one display area to another display area when a move command is input.

### BRIEF DESCRIPTION OF THE DRAWINGS

The above and/or other aspects and advantages of the invention will become apparent: and more readily appreciated from the following description of the embodiments, taken in conjunction with the accompanying drawings of which:

FIG. 1 is a block diagram of a user-interface-providing apparatus according to an embodiment of the present invention;

FIG. 2 depicts a screen which provides a plurality of display areas according to an embodiment of the present invention;

FIG. 3 depicts a state of moving a pointing object according to an embodiment of the present invention;

FIG. 4 depicts a change in size of a pointing object according to an embodiment of the present invention;

FIG. 5 is a flowchart showing a method of providing a user interface according to an embodiment of the present invention;

FIG. 6 depicts external components of a portable broadcast-receiving device according to an embodiment of the present invention;

FIG. 7 is a block diagram showing a structure of a portable broadcast receiving device according to an embodiment of the present invention;

FIGS. 8A to 8C depict a user interface according to an embodiment of the present invention;

FIGS. 9A to 9C depict a user interface according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. The embodiments are described below in order to explain the present invention by referring to the figures.

The term “module,” as used herein, refers to, but is not limited to, a software or hardware component, such as, for example, a Field Programmable Gate Array (FPGA) or an Application Specific Integrated Circuit (ASIC), which executes certain tasks. A module may be advantageously configured to reside in an addressable storage medium, and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. It is understood that other types of modules and/or components may be used in accordance with aspects of the present invention, and that other configurations of the modules and/or components may be used.

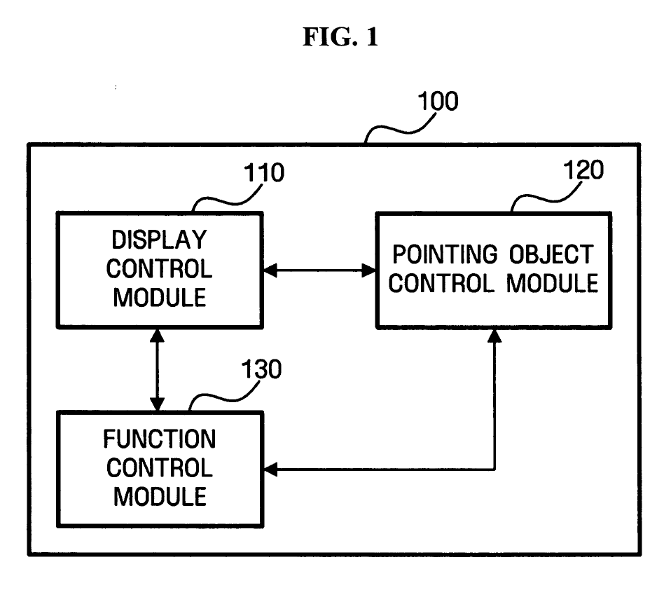

FIG. 1 is a block diagram of an apparatus which provides a user interface according to an embodiment of the present invention. The user-interface-providing apparatus 100 includes a display control module 110, a pointing object control module 120, and a function control module 130. The user-interface-providing apparatus may be included not only in a portable digital device, such as a digital camera, cellular phone, portable media player (PMP), personal digital assistant (PDA), or DMB receiver, but also may be included in a stationary digital device, such as a digital TV or set-top box. The user-interface-providing apparatus 100 may be embodied as one or more modules in a digital device.

The user-interface-providing apparatus 100 enables a user to control a digital device by providing a pointing object to the user. Hereinafter, components of the user-interface-providing apparatus 100 will be described. A digital device including the user-interface-providing device 100 will be hereinafter referred to as a “main device” for convenience.

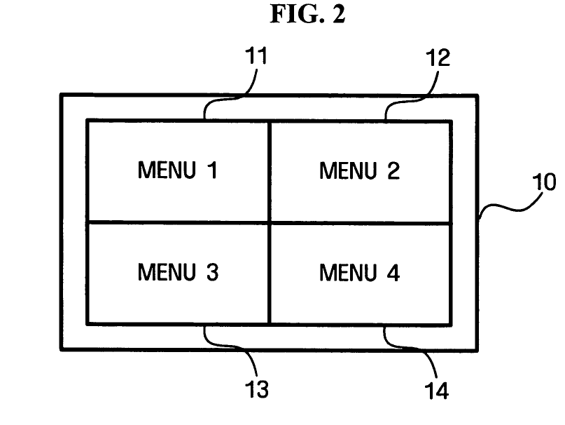

The display control module 110 provides one or more display areas on a screen of the main device. Each display area maps several control subjects which control the main device, and displays visual information indicating each control subject. The control subject may be presented on the screen in several different embodiments corresponding to different functions provided by the main device. For example, the control subjects may be various menus which allow a user to select a function of the main device. FIG. 2 illustrates an example of a screen which provides a plurality of display areas via the display control module 110. Referring to FIG. 2, a screen 10 provides a plurality of display areas 11-14, and each display area 11-14 displays a menu 1-4, respectively, which allows a user to control the main device.

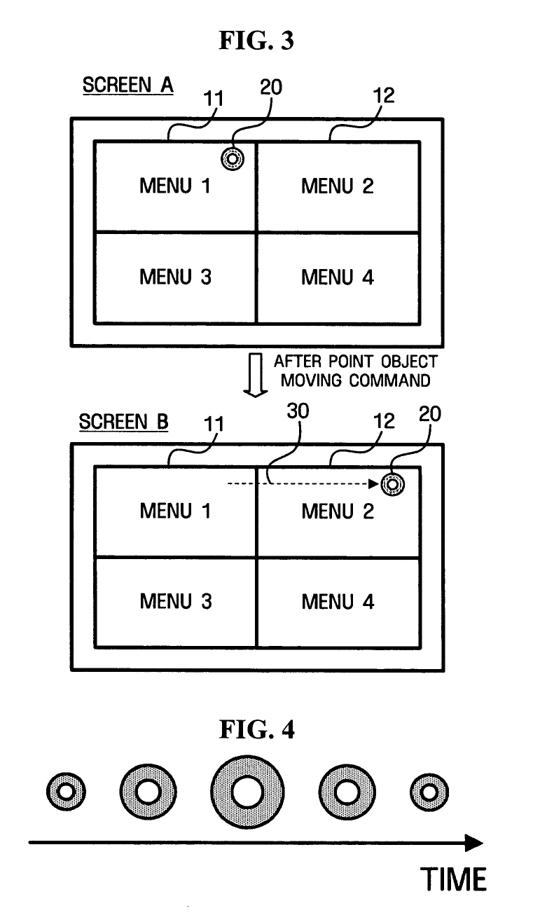

The pointing object control module 120 controls a pointing object which in turn controls a control subject. The pointing object may be located on one display area of a plurality of display areas provided by the display control module 110. If a moving command of the pointing object is input, the pointing object control module 120 moves the pointing object in a direction corresponding to the move command to a display area adjacent to the display area where the pointing object was originally located. Preferably, the pointing object continuously moves while overlapping the display areas so that the pointing object may be continuously moved between display areas, which will be described with reference to FIG. 3. In a state where the pointing object 20 is located in a display area 11 with a menu 1 like screen A, when a user inputs a command to move a pointing object 20 to the right, the pointing object 20 is moved to a display area 12 corresponding to a menu 2. A screen B shows a moving state of the pointing object 20. The arrow attached to the dotted line 30 illustrates an example of the path of the pointing object 20. It is understood that the pointing object may also be moved from menu 1 to menus 3-4, as well as into any other menus displayed on screens A and/or B.

In FIG. 3, the pointing object 20 is illustrated as a hollow circle; however, it may be illustrated as many other images. The pointing object may also appear to be a three-dimensional figure or icon. In other words, the pointing object according to an embodiment of the present invention is not limited to the shape or form displayed in FIG. 3, and may instead be numerous other shapes or forms.

The pointing object's size, shape, form, color, and brightness can change. For example, the pointing object's size may change over a certain range of sizes over time. Likewise, the pointing object's shape, form, color, and brightness can change over time. The pointing object's size, shape, form, color, and brightness may also change even when a user moves the pointing object between display areas. A user can identify or select a display area corresponding to a control subject via the pointing object.

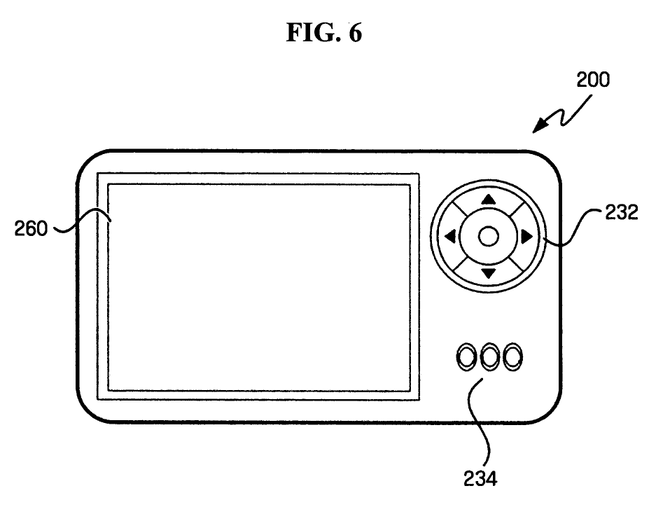

When a user inputs a control command in a display area, a function-control module 130 performs a control operation on the control subject corresponding to a display area. The result of the control command inputted by a user into the function-control module 130 is displayed via the display control module 110. The control operation performed by the function-control module 130 may be several different embodiments, based on a function provided by the main device, which will be described with reference to FIGS. 6 to 9C.

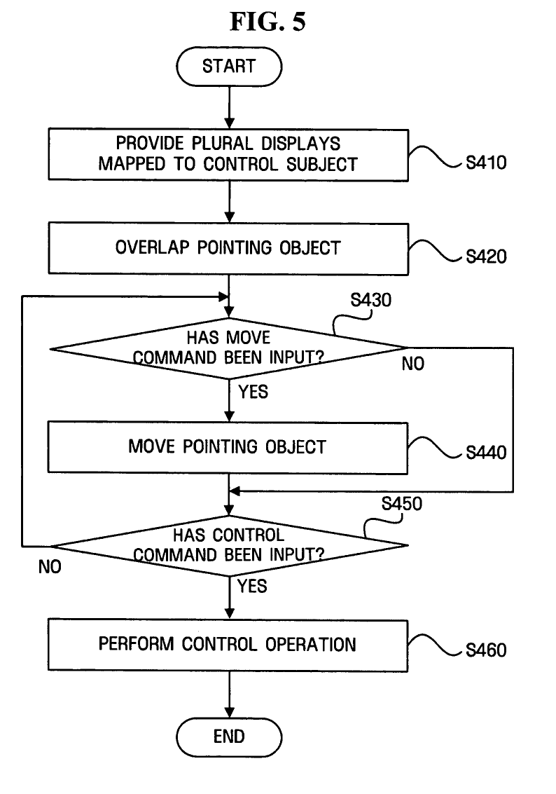

Hereinafter, operations between modules which constitute a user-interface-providing apparatus will be described with reference to FIG. 5.

FIG. 5 is a flowchart which shows a method of providing a user interface according to an embodiment of the present invention.

In operation S410, a display control module 110 provides a plurality of display areas corresponding to a plurality of control subjects via a screen of the main device.

Then, in operation S420, the pointing object control module 120 positions a pointing object on one display area of the plurality of display areas provided by the display control module 110.

If a user inputs a move command to the main device in operation S430, then in operation S450, the pointing object control module 120 moves the pointing object to a display area located in the direction corresponding to the move command. It is understood that the move command may be inputted in many different ways. For instance, a clockwise rotation of a direction button may move the pointing object in a clockwise manner around the display areas.

After a user inputs a control command in operation S450, then in operation S460, the function control module 130 performs a control operation on a control subject displayed in the display area where the pointing object is located.

In one embodiment, the main device including the user-interface-providing apparatus 100 is a portable broadcast-receiving device. However, it is understood that the main device is not limited to being a portable broadcast-receiving device. The main device may also be a stationary device, such as a digital TV.

FIG. 6 depicts external components of a portable broadcast-receiving device according to an embodiment of the present invention.

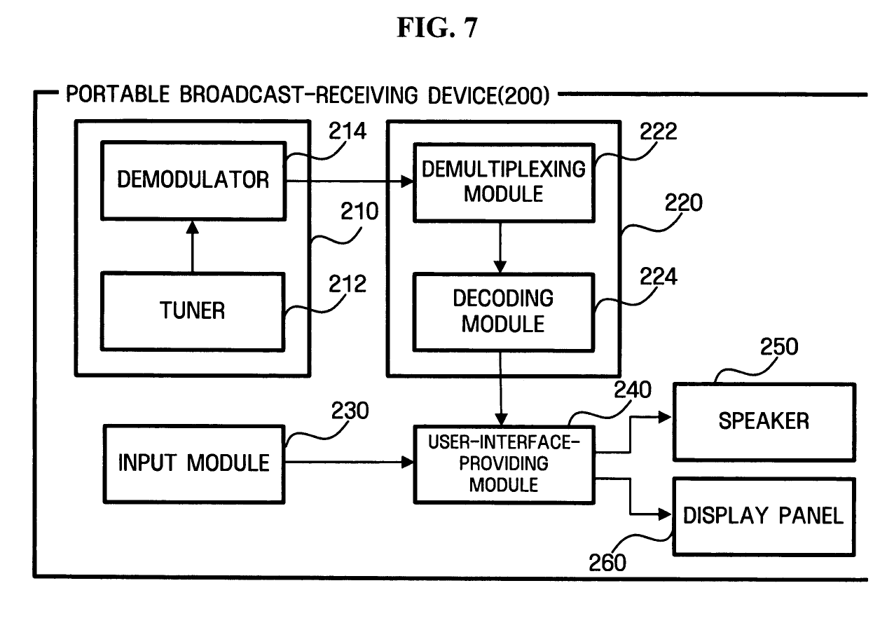

A portable broadcast-receiving device 200 includes a display panel 260 and a plurality of buttons, such as a direction button 232 and a function 234. The portable broadcast-receiving device 200 receives a broadcast signal transmitted by a broadcasting station, decodes the received broadcast signal, and displays the signal via a display panel. When the portable broadcast-receiving device 200 displays a user interface, which enables a user to select a control subject, such as a menu or a received broadcast, the portable broadcast-receiving device 200 provides a pointing object to select the control subject. In other words, the pointing object shows a control position to a user. A particular structure of the portable broadcast receiving device 200 is shown in FIG. 7.

FIG. 7 is a block diagram showing a portable broadcast receiving device according to an embodiment of the present invention.

The portable broadcast receiving device 200 illustrated in FIG. 7 includes a broadcast signal-receiving module 210, a restoration module 220, an input module 230, a user interface-providing module 240, a speaker 250, and a display panel 260. The broadcast signal-receiving module 210 and restoration module 220 may also be collectively referred to as a receiving unit. It is understood that portable broadcast receiving devices are not limited to the configuration shown in FIG. 7, and may instead have various other configurations.

The broadcast signal receiving module 210, which includes a tuner 212 and a demodulator 214, receives a broadcast signal.

The tuner 212 receives a broadcast signal, converts the received broadcast signal into an intermediate frequency (IF), and transmits the IF to the demodulator 214. For example, the tuner 212 detects an in-phase/quadrature-phase (I/Q) signal by processing signals received via satellite, and then transmits the detected I/Q signal to the demodulator 214. It is understood that signals other than I/Q signals may also be received by the tuner 212.

The demodulator 214 abstracts a transport stream (TS) from the IF and then transmits the abstracted TS to the restoration module 220. The demodulator 214 may be, for example, a quadratic phase shift keying (QPSK) demodulator (not shown) and a forward error correction (FEC) demodulator (not shown) and perform QPSK demodulation and FEC demodulation. It is understood that other methods of abstraction and/or other components may be used.

The TS may include at least one of video, audio, and data signals. In other words, the TS may include video signals, audio signals, and/or data signals.

The broadcast signal received by the broadcast-signal-receiving module 210 may be one of a satellite DMB and a terrestrial wave DMB, but is not limited to being either a satellite DMB or a terrestrial wave DMB. The broadcast-signal-receiving module 210 may additionally or instead receive a different type of broadcast signal, such as a digital video broadcasting (DVB) signal or a digital audio broadcasting (DAB) signal.

The restoration module 220 restores video, audio, and data signals in the TS. To restore the video, audio and data signals, the restoration module 220 includes a demultiplexing module 222 and a decoding module 224. It is understood that the restoration module 220 may use other modules to restore the video, audio and data signals.

Depending on the type of broadcast signal received by the portable broadcast receiving device, the TS may include at least one of video, audio, and data signals. The demultiplexing module 222 separates the video, audio, and data signals by parsing the TS, and then transmits the parsed data signals to the decoding module 224.

The decoding module 224 includes a video decoder (not shown) and an audio decoder (not shown). Both the video decoder and the audio decoder decode the parsed video and audio signals transmitted by the demultiplexing module 222. A video decoder 310 may use a video decompression method, such as MPEG-2 and MPEG-4, to decode the video signal. An audio decoder 320 may use an audio decompression method, such as the MPEG layer 3 (MP3) or audio compression 3 (AC3), to decode the audio signal.

Additionally, the decoding module 224 may include a data decoder (not shown). The data decoder decodes the data signals transmitted by the demultiplexing module 222. The data decoder may use a video decompression method, such as JPEG, or a markup language parsing method, such as an extensible markup language (XML) parser, to decode the data.

The input module 230 includes a plurality of buttons, such as the direction button 232 and the function button 234, which outputs a command corresponding to each button pushed by a user. It is understood that these buttons may output a wide variety of commands.

The user-interface-providing module 240 transmits the broadcast signal restored by the restoration module 220 to the user via the speaker 250 and the display panel 260. Additionally, the user-interface-providing module 240 provides various menus needed to control the portable broadcast-receiving device 200, and outputs these menus to the user via the display panel 260. Specifically, the user-interface-providing module 240 enables a user to control the portable broadcast-receiving device 200 with a pointing object and the input module 230.

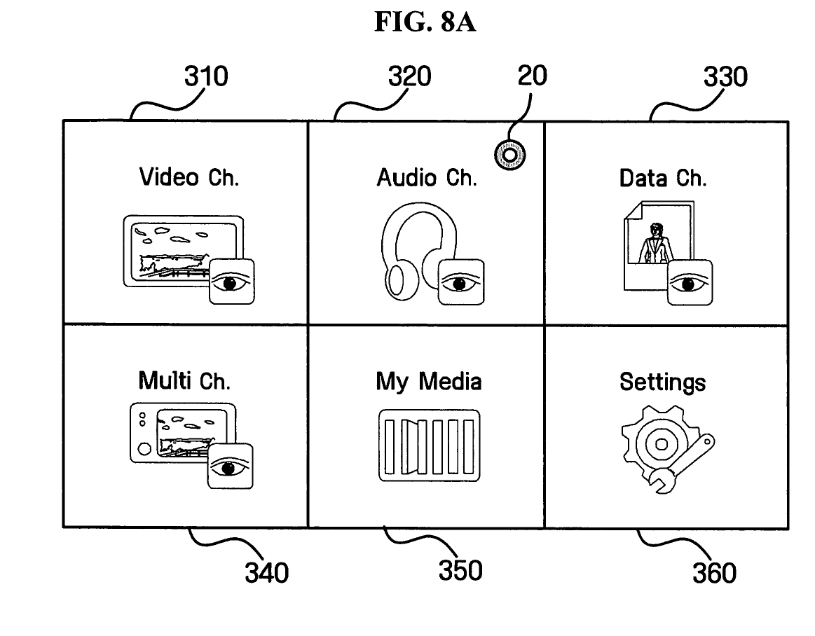

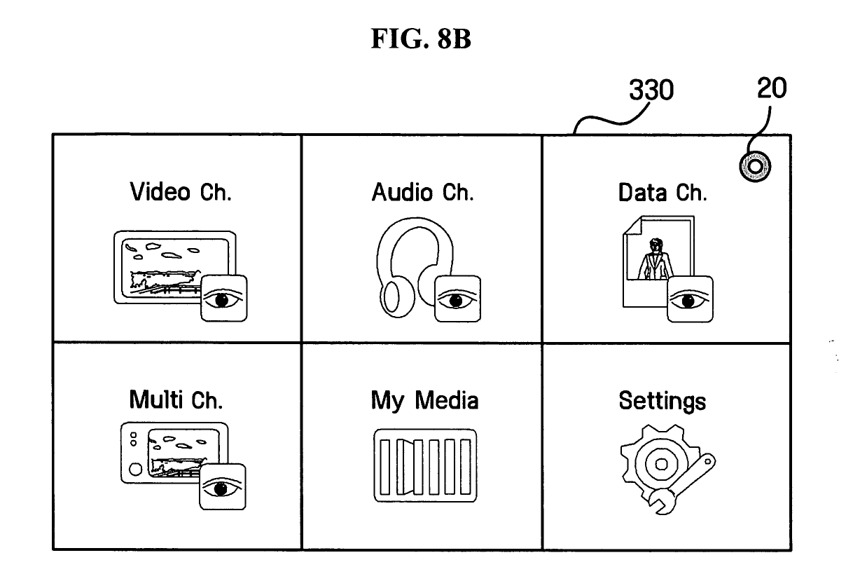

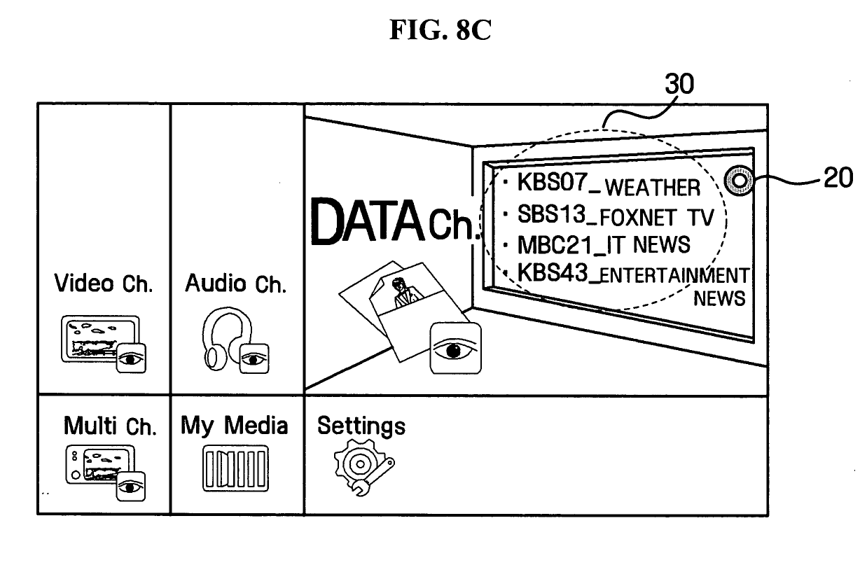

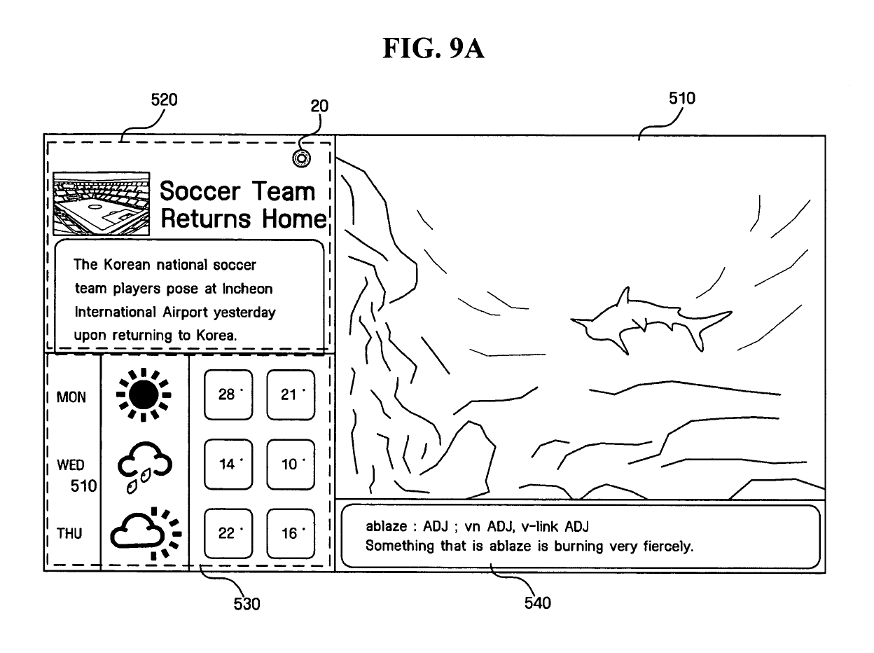

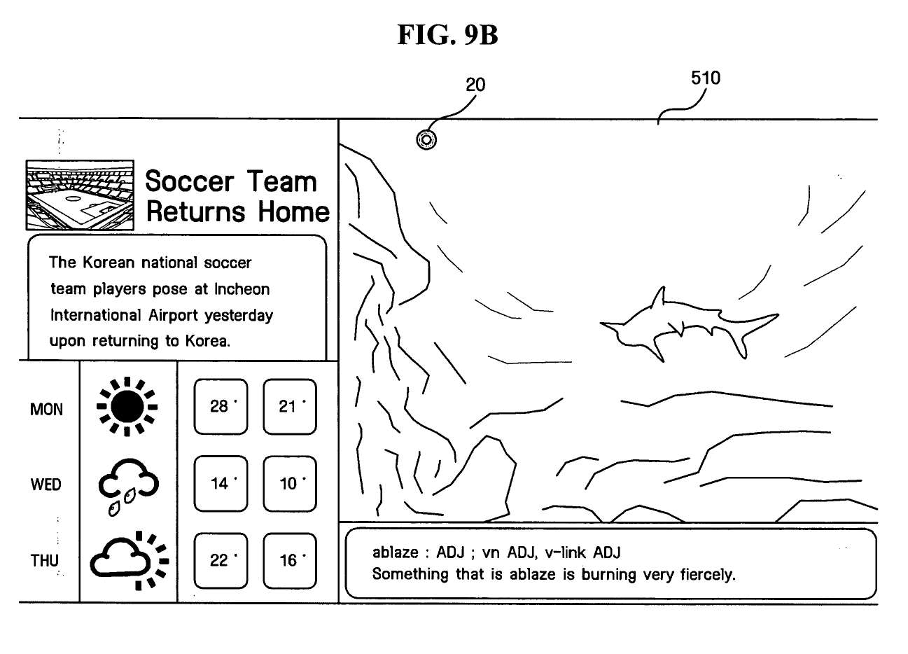

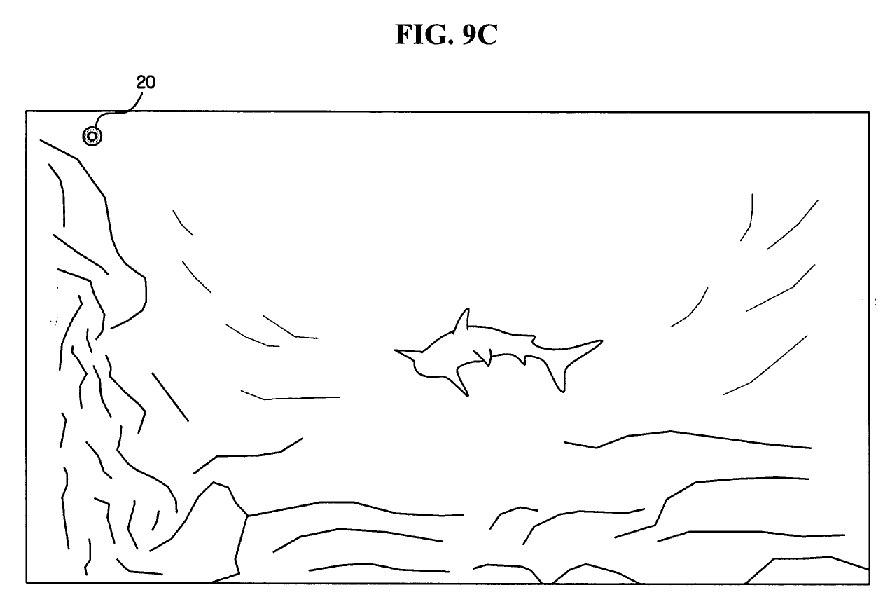

The user-interface-providing module 240 is in a state where the user-interface-providing apparatus 100 described with reference to FIGS. 1 to 5 is modularized. In other words, the structure and operation of the user-interface-providing module 240 may be understood to be the same structure and operation of the user interface providing apparatus 100. Hereinafter, it will be described that the portable broadcast-receiving device 200 provides a user interface via the user-interface-providing module 240, with reference to FIGS. 8A to 9C. A structure of the user interface providing module 240 will be described with reference to that of the user interface providing apparatus 100 illustrated in FIG. 1.

FIG. 8A depicts a user interface according to an embodiment of the present invention. The illustrated user interface includes six display areas 310, 320, 330, 340, 350 and 360. In each of the display areas 310, 320, 330, 340, 350 and 360, a video channel menu to select a video broadcast, an audio channel menu to select an audio broadcast, a data channel menu to a data broadcast, a multi-channel menu to view several broadcasts simultaneously, a “my media” menu to store and search for the user's favorite channels, and a setting menu to set an environment of the portable broadcast-receiving device 200, are all displayed. These screens may be displayed to the user by the display control module 110 of the user-interface-providing module 240.

In FIG. 8A, the pointing object 20 is located in the display area 320 corresponding to the audio channel menu.

If a user inputs a command to move the pointing object 20 to the right by using the direction button 232, the input module 230 sends the corresponding key signal to the user-interface-providing module 240. At this point, the pointing object control module 120 of the user-interface-providing module 240 moves the pointing object to the display area 330 on the right (adjacent to the display area 320 corresponding to audio channels), which is illustrated in FIG. 8B. It is understood that buttons other than the direction button 232 may be used to move the pointing object 20.

If a user inputs a control command by pressing the function button 234, the function button 234 transmits the control command to the user-interface-providing module 240 via the input module 230. In FIG. 8B, the function control module 130 of the user-interface-providing module 240 performs the control operation corresponding to the function button 234 on a data channel menu in the display area 330 where the pointing object 20 is located. In FIG. 8B, if a user inputs a command to request a sub-menu by using the function button 234, the function control module 130 provides sub-menu items of the data channel menu corresponding to the display area where the pointing object 20 is located. Here, the sub-menu items are displayed on a display area of the display panel 260 by the display control module 110, an embodiment of which is illustrated in FIG. 8C.

FIG. 8C illustrates a data broadcast list as a sub-menu of the data channel menu. As illustrated in FIG. 8C, when a sub-menu 30 is displayed, the pointing object 20 moves to onto one of the sub-menu items, which are also control subjects. Accordingly, a user may control these sub-menu items via the pointing object 20. As further illustrated in FIG. 8C, when a user moves the pointing object 20 to a display area, the display area enlarges and cause a corresponding decrease in the size of the other display areas. It is understood that the display area does not have to enlarge when a user moves the pointing object 20 into the display area, or may enlarge or change appearance in various ways other than the way illustrated in FIG. 8C.

The pointing object 20 may be continuously displayed on a screen even when a user views a broadcast via a portable broadcast-receiving device, an example of which is illustrated in FIGS. 9A to 9C. However, it is understood that the pointing object 20 does not have to be continuously displayed on the screen.

FIG. 9A depicts a user interface according to another embodiment of the present invention. The illustrated user interface shows a state where several broadcasts are displayed by a selection of the display area 340 corresponding to the multi-channel menu. In this case, a video broadcast is displayed in the first display area 510, and data broadcasts are displayed in the second display area 520, the third display area 530, and the fourth display area 540. In FIG. 9A, the pointing object 20 is located on the second display area 520.

If a user inputs a move command, the pointing object 20 moves to the first display area 510 on the right (adjacent to the second display area 520), as illustrated in FIG. 9B.

If a user inputs a control command by pressing the function button 234, a control operation for a video broadcast displayed in the first display area 510 is performed. If a user inputs a whole screen command, a video broadcast displayed in the first display area 510 is displayed on the whole screen, as illustrated in FIG. 9C. It is understood that the function button 234 may perform various functions.

According to aspects of the present invention, the method and the apparatus for providing a user interface enables a user to easily control a portable terminal.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing a user interface to a user, comprising:
displaying a plurality of display areas on a screen, wherein each display area displays at least one control subject;
positioning a pointing object onto one of the control subjects, and
moving the pointing object between the display areas when a move command is input.

2. The method of claim 1, further comprising performing a control operation on the control subject located in the display area where the pointing object is positioned by inputting a control signal.

3. The method of claim 1, wherein the control subject comprises a menu which controls a portable broadcast-receiving device.

4. The method of claim 3, wherein the control subject further comprises a sub-menu which controls a display area.

5. The method of claim 1, wherein the control subject comprises at least one of video, audio, and data broadcasts.

6. The method of claim 1, wherein the pointing object comprises an icon representing a two-dimensional figure.

7. The method of claim 1, wherein the pointing object comprises an icon representing a three-dimensional figure.

8. The method of claim 1, wherein at least one of the pointing object's shape, form, color, and brightness changes over time and/or when the pointing object is moved.

9. An apparatus which provides a user interface, comprising:
a display control module, comprising:
a plurality of display areas which display control subjects, wherein each display area displays at least one control subject, and
a pointing object control module which moves a pointing object displayed on one display area to another display area when a move command is input.

10. The apparatus of claim 9, further comprising a function control module which performs a control operation on a control subject on which the pointing object is located when a control signal is input.

11. The apparatus of claim 8, wherein the control subject comprises a menu which controls a portable broadcast-receiving device.

12. The apparatus of claim 11, wherein the control subject further comprises a sub-menu which controls a display area.

13. The apparatus of claim 9, wherein the control subject comprises at least one of video, audio, and data broadcasts.

14. The apparatus of claim 9, wherein the pointing object comprises an icon which represents a two-dimensional figure.

15. The apparatus of claim 9, wherein the pointing object comprises an icon which represents a three-dimensional figure.

16. The apparatus of claim 9, wherein at least one of the pointing object's shape, form, color, and brightness changes over time and/or when the pointing object is moved.

17. A method of providing a user interface to a user, comprising:
receiving a plurality of digital broadcasts with a portable broadcast receiving device;
displaying the plurality of digital broadcasts in a corresponding plurality of display areas displayed on a screen of the portable broadcast receiving device; and
using a pointing object control module to move a pointing object between the display areas to select different digital broadcasts.

18. The method of claim 17, further comprising entering a command onto the display area which the pointing object is located on by pressing a function button located on the portable broadcast-receiving device.

19. The method of claim 18, wherein the entering of the command enlarges the display area.

20. The method of claim 17, wherein the plurality of digital broadcasts comprises at least one of digital video, digital audio, and digital data broadcasts.

21. The method of claim 17, wherein the pointing object comprises an icon which represents a two-dimensional icon.

22. The method of claim 17, wherein the pointing object comprises an icon which represents a three-dimensional icon.

23. The method of claim 17, wherein at least one of the pointing object's shape, form, color, and brightness changes over time and/or when the pointing object is moved.

24. An apparatus which provides a user interface, comprising:
a portable broadcast receiving device which receives a digital broadcast, comprising:
a display panel which displays the digital broadcast in a display area, and
a pointing object control module, wherein a movement of the pointing object control module causes a corresponding movement of a pointing object which allows a user to navigate the pointing object around the display area.

25. The apparatus of claim 24, further comprising a function control module which performs a control operation on the display area on which the pointing object is located when a control signal is input.

26. The apparatus of claim 25, wherein the display area displays a menu which controls the portable broadcast-receiving device.

27. The apparatus of claim 26, wherein the menu displays a sub-menu when the pointing object is moved onto the menu by the user.

28. The apparatus of claim 24, wherein the display area displays at least one of video, audio, and data broadcasts.

29. The apparatus of claim 24, wherein the pointing object comprises an icon which represents a two-dimensional figure.

30. The apparatus of claim 24, wherein the pointing object comprises an icon which represents a three-dimensional figure.

31. The apparatus of claim 24, wherein at least one of the pointing object's shape, form, color, and brightness changes over time and/or when the pointing object is moved.
